(19) United States
(12) Patent Application Publication
(10) Pub. No.: US 2007/0262694 A1
(43) Pub. Date: Nov. 15, 2007

(54) LIGHT-EMITTING DEVICE

(76) Inventors: Satoshi MIKOSHIBA, Yamato-shi (JP); Tomoko Eguchi, Yokohama-shi (JP); Takashi Kuboki, Tokyo (JP); Takashi Kishi, Yokosuka-shi (JP); Tsuyoshi Kobayashi, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/683,738

(22) Filed: Mar. 8, 2007

(30) Foreign Application Priority Data
May 15, 2006 (JP) 2006-135724

(51) Int. Cl. H01J 1/62

(52) U.S. Cl. 313/483

(57) ABSTRACT

A light-emitting device is provided, which includes a first electrode, a second electrode electrically isolated from the first electrode, and a luminescence layer formed of an electrolyte and disposed to contact with both of the first electrode and second electrode. The electrolyte comprises a luminous pigment which emits light, an ionic liquid, and carbonate. The carbonate is solid at normal temperature.

### CROSS-REFERENCE TO RELATED APPLICATIONS

This application is based upon and claims the benefit of priority from prior Japanese Patent Application No. 2006-135724, filed May 15, 2006, the entire contents of which are incorporated herein by reference.

### BACKGROUND OF THE INVENTION

1. Field of the Invention

This invention relates to a light-emitting device.

2. Description of the Related Art

There is known a light-emitting device wherein a mechanism of the electrochemical reaction of luminous pigment is utilized in the emission of light. In this kind of light-emitting device, part of luminous pigment contained in an electrolyte is oxidized at a positive (+) electrode and the balance of the luminous pigment is reduced at a negative (−) electrode. The oxidant and reductant thus created are enabled to collide with each other to generate phosphorescence, thereby allowing the oxidant and reductant to return to the original luminous material of ground state. There has been published a light-emitting device wherein the aforementioned principle is utilized and constructed to comprise a porous layer.

In this electrochemical light-emitting device, an SnO₂/F transparent conductive film formed on a glass substrate is employed as a negative electrode. The glass substrate bearing this SnO₂/F transparent conductive film is further provided on the outer surface thereof with an aluminum layer acting as a reflection film. As the counter electrode, a glass substrate having an SnO₂/F transparent conductive film formed thereon is employed. An electrolyte comprising ruthenium complex dissolved in acetonitrile is employed. In this case, the enhancement of emission luminance is achieved by providing a porous layer consisting of nanotitania crystal on the SnO₂/F transparent conductive film employed as a negative electrode.

The electrochemical light-emitting device is now required to be further improved in emission luminance and also required to be driven at a further reduced driving voltage. However, no one has succeeded as yet to achieve these requirements.

### BRIEF SUMMARY OF THE INVENTION

A light-emitting device according to one aspect of the present invention comprises a first electrode; a second electrode electrically isolated from the first electrode; and a luminescence layer formed of an electrolyte and disposed to contact with both of the first electrode and second electrode, the electrolyte comprising a luminous pigment which emits light, an ionic liquid, and carbonate, the carbonate being solid at normal temperature.

A light-emitting device according to another aspect of the present invention comprises a first electrode; a second electrode disposed to face the first electrode and spaced apart therefrom; and a luminescence layer formed of an electrolyte and interposed between the first electrode and the second electrode to contact with both of the first electrode and second electrode, the electrolyte comprising a luminous pigment which emits light, an ionic liquid, and carbonate, the carbonate being solid at normal temperature.

A light-emitting device according to a further aspect of the present invention comprises an insulating substrate; a first tandem electrode disposed on the insulating substrate; a second tandem electrode disposed to electrically insulate from the first tandem electrode and formed on the insulating substrate; and a luminescence layer formed of an electrolyte and interposed to contact with both of the first tandem electrode and second tandem electrode, the electrolyte comprising a luminous pigment which emits light, an ionic liquid, and carbonate, the carbonate being solid at normal temperature.

### BRIEF DESCRIPTION OF THE SEVERAL VIEWS OF THE DRAWING

FIG. 1 is a cross-sectional view of a light-emitting device according to one embodiment;

FIG. 2 is a cross-sectional view of a light-emitting device according to another embodiment;

FIG. 3 is a cross-sectional view of a light-emitting device according to a further embodiment;

FIG. 4 is a plan view of a first substrate employed in the light-emitting device shown in FIG. 3; and

FIG. 5 is a cross-sectional view of a light-emitting device according to a further embodiment.

### DETAILED DESCRIPTION OF THE INVENTION

Next, embodiments will be explained with reference to drawings.

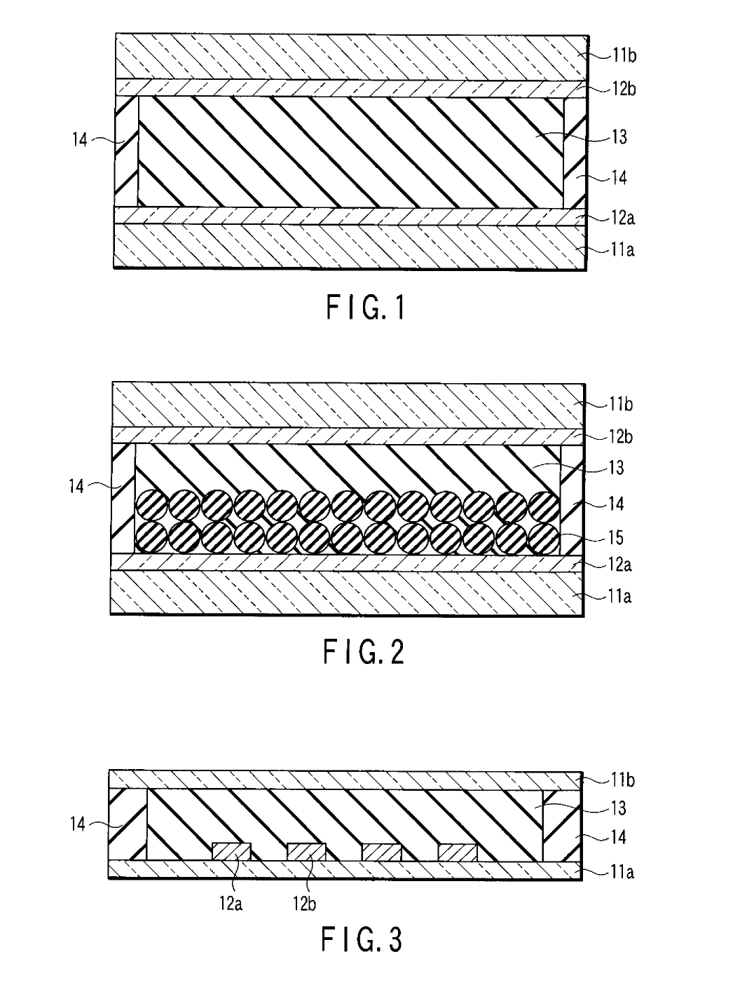

In the light-emitting device shown in FIG. 1, a first electrode 12a and a second electrode 12b are disposed to face each other with a spacer 14 being interposed therebetween. Between these electrodes 12a and 12b is disposed a luminescence layer 13 which is formed of an electrolyte. The first electrode 12a and the second electrode 12b are supported by a first substrate 11a and a second substrate 11b, respectively.

Among these first substrate 11a and second substrate 11b, at least the electrode which is located closer to a light-emitting surface is required to be transparent. Namely, the electrode (for example, the first electrode 12a) which is located closer to a light-emitting surface may be formed by a transparent conductive film. As materials for the transparent conductive film, it is possible to preferably employ a tin oxide film doped with fluorine or indium, or a zinc oxide film doped with fluorine or indium.

With respect to the electrode which is located on the other side (for example, the second electrode 12b), it may be also formed of a transparent conductive film. In this case, in view of enhancing the electrical conductivity to prevent any increase of electrical resistance, it is preferable to form the wiring by a low resistance metal matrix in combination with a transparent conductive film. Alternatively, the second electrode 12b may be constituted by a metal substrate or an alloy substrate. If the second electrode 12b is to be constituted by these materials, the second substrate 11b for supporting the second electrode 12b may not necessarily be required to be employed. The electrode to be disposed on the surface opposite to the light-emitting surface may be formed by carbon sheet, metal or alloy. As the carbon sheet, there is not any particular limitation as long as the carbon material thereof functions as a conductive component.

Provided that the first electrode 12a can be kept insulated from the second electrode 12b, the first electrode 12a and the second electrode 12b may be formed on the same substrate. As described hereinafter, the first electrode 12a and the second electrode 12b, both being configured as a tandem electrode, may be arranged so as to form a staggered pattern on an insulating substrate. As the insulating substrate, it is possible to employ, for example, a glass substrate, a resin substrate such as an epoxy resin substrate, an acrylic resin substrate, etc.

If a transparent conductive film is to be employed for the formation of at least one of the first electrode 12a and the second electrode 12b, the substrate thereof should preferably be arranged as shown in FIG. 1. In order to enable the outer surface of the substrate bearing thereon a transparent conductive film to function as a light-emitting surface, it is desirable to employ a transparent substrate which is low in absorption of light of visible light zone such as a glass substrate, a transparent plastic substrate, etc.

Between these first electrode 12a and second electrode 12b as described above, there is disposed a luminescence layer 13 formed of an electrolyte. This electrolyte comprises a luminous pigment, an ionic liquid, and carbonate which is solid at normal temperature.

As the luminous pigment, it is possible to employ a phosphorescence pigment which forms a reversible redox structure. Since this phosphorescence pigment is high in probability of intersystem crossing of the transition between metal-ligand, this phosphorescence pigment should preferably be formed of a complex of heavy metals. As examples of the heavy metals to be employed in this case, they include Ir, Tb, Yb, Nd, Er, Ru, Os and Re. One or more kinds of heavy metals may be contained in the complex. As the ligand, it is possible to employ pyridine derivatives, bipyridyl derivatives, terpyridyl derivatives, phenanthroline derivatives, quinoline derivatives, acetylacetone derivatives, dicarbonyl derivatives, etc. When the efficiency of transition of metal-ligand is taken into account, the employment of bipyridyl derivatives is most preferable.

Because of high luminescence intensity, a complex having Ru as a center metal is preferable. More specifically, it is possible to employ ruthenium (II) trisbipyridyl (PF₆⁻)₂, ruthenium (II) trisbipyridyl (TFSI⁻)₂, etc.

The ionic liquid is a room temperature molten salt which is liquid at normal temperature (25° C.) and should preferably be comprise a cation having a structure represented by the following general formula (A).

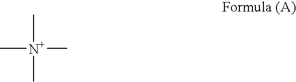

As examples of the cation having a structure represented by above general formula (A), they include N,N,N-trimethylbutyl ammonium ion, N-ethyl-N,N-dimethylpropyl ammonium ion, N-ethyl-N,N-dimethylbutyl ammonium ion, N,N-dimethyl-N-propylbutyl ammonium ion, N-(2-methoxyethyl)-N,N-dimethylethyl ammonium ion, 1-ethyl-3-methyl imidazolium ion, 1-ethyl-2,3-dimethyl imidazolium ion, 1-ethyl-3,4-dimethyl imidazolium ion, 1-ethyl-2,3,4-trimethyl imidazolium ion, 1-ethyl-2,3,5-trimethyl imidazolium ion, N-methyl-N-propyl pyrrolidinium ion, N-butyl-N-methyl pyrrolidinium ion, N-sec-butyl-N-methylpyrrolidinium ion, N-(2-methoxyethyl)-N-methylpyrrolidinium ion, N-(2-ethoxyethyl)-N-methylpyrrolidinium ion, N-methyl-N-propyl piperidinium ion, N-butyl-N-methyl piperidinium ion, N-sec-butyl-N-methyl piperidinium ion, N-(2-methoxyethyl)-N-methyl piperidinium ion and N-(2-ethoxyethyl)-N-methyl piperidinium ion.

Because of the wide potential window, N-methyl-N-propyl piperidinium ion is most preferable as the cation.

On the other hand, as the anion, it is possible to employ, for example, PF₆⁻, [PF₃(C₂F₅)₃]⁻, [PF₃(CF₃)₃]⁻, BF₄⁻, [BF₂(CF₃)₂]⁻, [BF₂(C₂F₅)₂]⁻, [BF₃(CF₃)]⁻, [BF₃(C₂F₅)]⁻, [B(COOCOO)₂]⁻(BOB⁻), CF₃SO₃⁻(Tf⁻), C₄F₉SO₃⁻(Nf⁻), [(CF₃SO₂)₂N]⁻ (TFSI⁻), [(C₂F₅SO₂)₂N]⁻(BETI⁻), [(CF₃SO₂)(C₄F₉SO₂)N]⁻, [(CN)₂N]⁻(DCA⁻), [(CF₃SO₂)₃C]⁻, and [(CN)₃C]⁻. Because of the capability to reduce the viscosity of ionic liquid, the employment of BF₄⁻, [BF₃(CF₃)]⁻, [BF₃(C₂F₅)]⁻, BOB⁻, TFSI⁻ and BETI⁻ is most preferable.

The voltage which enables the aforementioned ionic liquid to electrochemically stably exist is around 2.5-3.0V. As the voltage becomes higher, the electrochemical oxidative or reductive decomposition reaction of the ionic liquid is increasingly promoted. Accordingly, as the voltage for driving the light-emitting device becomes smaller, the life of the electrolyte containing the ionic liquid can be further prolonged. It has been found out by the present inventors that this driving voltage can be reduced by incorporating carbonate which is solid at normal temperature (25° C.) into the electrolyte.

As examples of the carbonate which is solid at room temperature, they include, for example, ethylene carbonate, benzylphenyl carbonate, ethyl-m-tolyl carbonate, ethylphenyl carbonate, t-butyl-4-vinylphenyl carbonate, t-butylphenyl carbonate, t-butylethyl-3,5-xylyl carbonate, allylphenyl carbonate, diallyl carbonate and dibenzyl carbonate. These compounds may be employed singly or in combination of two or more. When carbonate is incorporated into the electrolyte, the voltage for initiating the emission of light of the light-emitting device can be reduced. Due to this reduction of the voltage for initiating the emission of light, the emission luminance at a predetermined voltage (for example, 3V) can be enhanced.

The mechanism that makes it possible to reduce the emission initiating voltage as described above has been interpreted by the present inventors as follows. Namely, in the ionic liquid containing a luminous pigment, the luminous pigment exists as a solvation in the ionic liquid. However, when the aforementioned carbonate which is solid at normal temperature is mixed with the ionic liquid, this condition of solvation is caused to change. Because of this, the oxidation and reduction energy of the pigment at the interface of the electrode is reduced, thus making it possible to reduce the emission initiating voltage. Especially, since ethylene carbonate is high in dielectric constant, ethylene carbonate is more prominent in the effect of reducing the emission initiating voltage. By the same reason as described above, dibenzyl carbonate is also capable of exhibiting almost the same effect as that of ethylene carbonate.

As the concentration (a ratio based on the total of the ionic liquid and carbonate) of carbonate may be optionally determined depending on the kind of carbonate to be employed. For example, in the case of ethylene carbonate, the concentration thereof should preferably be confined within the range of 3 to 40% by weight based on the total weight of the ionic liquid and the carbonate. When the concentration of ethylene carbonate is confined within this range, the driving voltage can be reduced without being governed by the emission initiating voltage of ethylene carbonate. The concentration of ethylene carbonate should preferably be confined to the range of 5 to 20% by weight based on the total weight of the ionic liquid and carbonate.

While the aforementioned ionic liquid is liquid at normal temperature, this carbonate is solid at normal temperature. Therefore, when they are mixed together, the mixing thereof should preferably be performed under heating.

The cell for the light-emitting device according to one embodiment can be constructed by disposing the first electrode 12a and the second electrode 12b so as to face each other with a spacer 14 being interposed therebetween as shown in FIG. 1. Further, an electrolyte is poured into the interstice created in the cell thus obtained to form the luminescence layer 13. Subsequently, the inlet port is closed using a sealing material such as epoxy resin, thus manufacturing the light-emitting device.

The light-emitting device according to one embodiment can be driven by applying direct or alternating current. In the case where an electrolyte comprising the ionic liquid containing a cation having a structure represented by the aforementioned formula (A) is to be used, it is preferable to select AC current. When AC current is employed in this case, the chance of collision between the oxidant and the reductant can be increased, thus making it possible to enhance luminescence intensity.

In the case of the light-emitting device shown in FIG. 2, a porous layer 15 is superimposed on the first electrode 12a. This porous layer 15 is effective in enhancing the luminescence intensity. This porous layer 15 should preferably be formed by fine particles of a material which exhibits virtually no tendency to produce irregular reflection. Especially preferable examples of such a material include rutile which is an n-type semiconductor, anatase and crystalline titania such as brookite. Among them, anatase is more preferable since anatase is relatively low in conductivity.

As for the particle diameter of the fine particles to be employed in this case, it is preferable that the particle diameter of the fine particles is confined within the range of 5 to 300 nm. The particle diameter of the fine particles can be measured by observation using SEM or TEM or by BET method. As long as the particle diameter of the fine particles is confined within the aforementioned range, it is possible to sufficiently enhance the emission luminance without generating irregular reflection. Moreover, there is no possibility of degrading the diffusion of ions. As for the thickness of the porous layer 15, it is preferable to confine it to the range of 1 to 50 μm or so. As long as the thickness of the porous layer 15 is confined within the aforementioned range, it is possible to sufficiently secure the effects of the porous layer 15 without bringing about problems such as the deterioration in diffusion of electrolyte and the increase of cell resistance.

Incidentally, although the porous layer 15 is depicted in FIG. 2 such that the fine particles are regularly arrayed in two rows, this is drawn merely for the purpose of convenience. Therefore, the fine particles constituting the porous layer may not necessarily be regularly arrayed so as to form rows but may be irregularly arranged. This is also applicable in other drawings to be discussed hereinafter.

The light-emitting device shown in FIG. 3 is constructed in the same manner as that shown in FIG. 1 except that a tandem electrode is employed as the first electrode 12a and also as the second electrode 12b and disposed on the first substrate 11a. As the first substrate 11a, it is possible to employ an insulating substrate such as a glass substrate or a resin substrate formed of epoxy resin, acrylic resin, etc. The electrode formed from fine particles is excellent in terms of the electrical resistance inside the electrode, the interface resistance thereof relative to an electrolyte, and the electrical contact thereof to the porous layer formed on the wiring. Further, the electrode can be formed by printing, it is possible to obtain a light-emitting device at lower cost as compared with the case wherein the conventional etching method is employed.

When a pair of tandem electrodes as described above are to be formed, it is possible to employ, as the first substrate 11a, an normal substrate which is not conductive. Since the second substrate 11b to be disposed to face the first substrate 11a acts as a light-emitting surface, the first substrate 11a is not required to be transparent. Therefore, the first substrate 11a may be formed of a glass substrate or an insulating substrate such as a resin substrate formed of epoxy resin, acrylic resin, etc. As the second substrate 11b, it is preferable to employ a transparent substrate which is low in absorption of visible light zone as already described above.

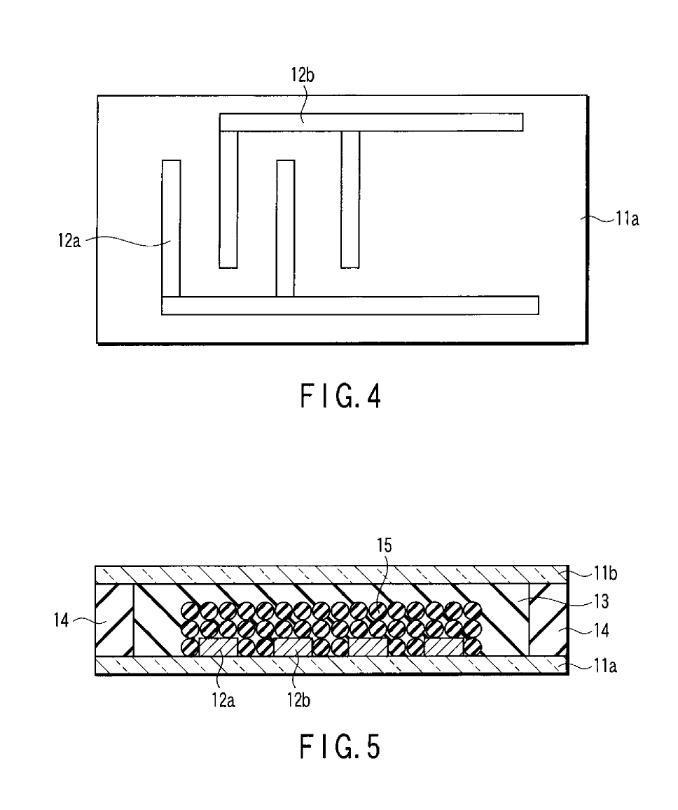

FIG. 4 shows a plan view of the first substrate 11a having a tandem first electrode 12a and a tandem second electrode 12b formed thereon. As shown in FIG. 4, the tandem first electrode 12a and the tandem second electrode 12b are disposed in a staggered manner on the first substrate 11a.

Even in the light-emitting device shown in FIG. 3, it is possible to enhance the emission luminance by disposing a porous layer on at least one of the first electrode 12a and the second electrode 12b. FIG. 5 shows a cross-sectional view of such a configuration of light-emitting device.

In the case of the light-emitting device according to the embodiment, since carbonate which is solid at normal temperature is incorporated in the electrolyte in addition to the luminous pigment and the ionic liquid, it is now possible to reduce the initiating voltage for driving the light-emitting device. Concomitant with the reduction of emission initiating voltage, the luminance at a predetermined voltage (for example, 3V) can be enhanced, thus making it possible to generate the emission of light with high luminance. Because of this low voltage driving, it is now made possible to prolong the life of electrolyte constituting the light-emitting layer.

Next, examples will be explained as follows.

(Sample 1)

First of all, a fluorine-doped tin oxide was deposited to a thickness of about 1 μm on a glass substrate having a thickness of 1 mm and employed as a first substrate 11a, thereby forming a first electrode 12a. The sheet resistance of the first electrode 12a thus obtained was 6 Ω/sq. The same kind of glass substrate as described above was prepared as a second substrate 11b, and a second electrode 12b was deposited on the glass substrate. The first electrode 12a and the second electrode 12b were disposed to face each other with an ionomer resin having a thickness of about 50 μm being interposed therebetween. Subsequently, the resultant composite structure was heated at a temperature of 100° C. for three minutes, thereby fixing them to each other.

On the other hand, 9.0 g of 1-ethyl-3-methyl imidazolium bis(trifluoromethyl sulfonyl) imide as an ionic liquid and 1.0 g of etheylene carbonate (EC) as carbonate which was solid at normal temperature were mixed together to obtain a mixture. This mixing process was performed under heating so as to decrease the viscosity of the ethylene carbonate. Further, 1.2 g of ruthenium(II) trisbipyridyl (PF₆⁻)₂ was added as a luminous pigment to the mixture to prepare an electrolyte. The content of ethylene carbonate (EC content) was 10 wt % based on the total weight of the ionic liquid and ethylene carbonate.

This electrolyte was introduced from an inlet port into the interstice between these electrodes and then the peripheries of the first electrode and the second electrode were sealed with epoxy resin to manufacture the light-emitting device as shown in FIG. 1.

When an AC current was passed through the light-emitting device in order to investigate the emission initiating voltage, the voltage was 1.7V. This emission initiating voltage represents a voltage at which a luminance of 1 cd/m², which is a minimum display unit, can be obtained in the case where BM-8 luminancemeter (Topcon Co., Ltd.) or a luminancemeter exhibiting the equivalent function to the BM-8 luminancemeter is employed. Further, the luminance at a voltage of 3V was 80 cd/m².

(Sample 2)

A first substrate and a second electrode were deposited on the same kind of glass substrate as described above by repeating the same procedures as in the case of Sample 1, and then a porous layer was formed on the first electrode.

The formation of the porous layer was performed as follows. First of all, 5 g of titanium oxide particles (Nippon Aerogel Co., Ltd.), 10 g of water, and 5 g of ethanol were mixed together to prepare a paste raw material for the porous layer. Then, this paste was printed on a predetermined region of the first electrode through a mask (50 μm in thickness) having a size of 5 mm×20 mm. The printed paste was dried by hot plate and sintered at a temperature of 450° C. for 30 minutes in an electric furnace. These steps of printing and drying were repeated four times to form a porous titania film having a thickness of 20 μm, thus obtaining the porous layer.

Meanwhile, an electrolyte was prepared in the same manner as described in Sample 1 except that the content of ethylene carbonate (EC content) based on the total weight of the ionic liquid and EC was changed to 5 wt %.

Further, a light-emitting device as shown in FIG. 2 was manufactured in the same manner as described in Sample 1 except that the first electrode provided with the aforementioned porous layer and the aforementioned electrolyte were employed.

When an AC current was passed through the light-emitting device in order to investigate the emission initiating voltage, the voltage was 2V. Further, the luminance at a voltage of 3V was 120 cd/m².

(Samples 3-12)

Light-emitting devices of Samples 3-12 were manufactured in the same manner as described in Sample 2 except that the EC content thereof was changed as shown in the following Table 1. In the same manner as described above, the emission initiating voltage of each of the light-emitting devices and the luminance at a voltage of 3V were investigated to obtain the results as summarized in the following Table 1. Incidentally, the results of the Samples 1 and 2 are also shown in Table 1.

TABLE 1

| | EC | Luminance | |
|---|---|---|---|
| Sample | content | at | Emission-initiating |
| No. | (wt %) | 3 V (cd/m²) | voltage (V) |
| 1 | 10 | 80 | 1.7 |
| 2 | 5 | 120 | 2.0 |
| 3 | 0 | 10 | 2.7 |
| 4 | 1 | 50 | 2.6 |
| 5 | 3 | 110 | 2.5 |
| 6 | 8 | 130 | 1.8 |
| 7 | 10 | 150 | 1.7 |
| 8 | 15 | 145 | 1.75 |
| 9 | 20 | 140 | 1.8 |
| 10 | 33 | 120 | 2.2 |
| 11 | 40 | 110 | 2.5 |
| 12 | 50 | 100 | 2.6 |

Since Sample No. 3 contained no ethylene carbonate, it represents a light-emitting device of comparative example. It will be seen from the results of Table 1 that due to the incorporation of ethylene carbonate (EC) in the electrolyte, it was possible to reduce the emission initiating voltage. Especially, when the content of EC was confined to the range of 3 to 40 wt %, it was possible to reduce the emission initiating voltage to 2.5V or less. Further, when the concentration of EC was confined to the range of 5 to 20 wt %, it was possible to reduce the emission initiating voltage to 2.0V or less.

Table 1 clearly shows that it was possible, through the reduction of emission initiating voltage, to enhance the luminance at a voltage of 3V.

Incidentally, Sample 7 was constructed in the same manner as Sample 1 except that it was further provided with the porous layer. It will be recognized from the comparison of these samples that due to the provision of the porous layer, it was possible to enhance the luminance of light-emitting device to not less than 1.8 times as high as that of the light-emitting device which was not provided with the porous layer.

(Sample 13)

An electrolyte was prepared in the same manner as described in Sample 1 except that the ionic liquid was changed to 7 g of N-methyl-N-propyl piperidinium bis(trifluoromethyl sulfonyl)imide and that the content of ethylene carbonate was changed to 3 g. Further, a light-emitting device was manufactured in the same manner as described in Sample 2 except that the electrolyte thus prepared was employed.

When an AC current was passed through the light-emitting device thus obtained in order to investigate the emission initiating voltage, the voltage was 1.8V. Further, the luminance at a voltage of 3V was 100 cd/m².

(Sample 14)

An electrolyte was prepared in the same manner as described in Sample 1 except that the ionic liquid was changed to 8 g of ethylmethyl imidazolium tetrafluoroborate and that the carbonate which was solid at normal temperature was changed to 2 g of ethylphenyl carbonate. Further, a light-emitting device was manufactured in the same manner as described in Sample 2 except that the electrolyte thus prepared was employed.

When an AC current was passed through the light-emitting device thus obtained in order to investigate the emission initiating voltage, the voltage was 1.6V. Further, the luminance at a voltage of 3V was 100 cd/m².

(Sample 15)

A glass substrate having a thickness of 1 mm was prepared as a first substrate. On this glass substrate was deposited a gold wiring 10 μm in line width, 5 μm in space between the lines, 100 nm in film thickness, and 2 mm×3 mm in area. In this manner, a first electrode 12a and a second electrode 12b were deposited on the first substrate 11a as shown in FIG. 4.

A glass substrate having a thickness of 1 mm was prepared as a second substrate 11b which was disposed to face the first substrate 11a. The first substrate 11a and the second substrate 11b were disposed to face each other with an ionomer resin having a thickness of 40 μm being interposed therebetween. Subsequently, these substrates were bonded to each other except the inlet port which was left as it was, thus obtaining a cell.

The same electrolyte as employed in Sample 1 was introduced into the cell and then the inlet port was sealed by ionomer resin, thereby manufacturing the light-emitting device as shown in FIG. 3.

When an AC current was passed through the light-emitting device thus obtained in order to investigate the emission initiating voltage, the voltage was 1.8V. Further, the luminance at a voltage of 3V was 500 cd/m².

(Sample 16)

An electrolyte was prepared in the same manner as described in Sample 1 except that the ionic liquid was changed to 9 g of trimethylpropyl ammonium bis(trifluoromethyl sulfonyl)imide and that the carbonate was changed to 1 g of dibenzyl carbonate. Further, a light-emitting device was manufactured in the same manner as described in Sample 15 except that the electrolyte thus prepared was employed.

When an AC current was passed through the light-emitting device thus obtained in order to investigate the emission initiating voltage, the voltage was 1.9V. Further, the luminance at a voltage of 3V was 530 cd/m².

(Sample 17)

A glass substrate having a thickness of 1 mm was prepared as a first substrate 11a. On this glass substrate was deposited a gold wiring 10 μm in line width, 5 μm in space between the lines, 100 nm in film thickness, and 2 mm×3 mm in area. Then, by the same paste raw material for forming a porous layer as employed in Sample 2, a porous layer was formed on the glass substrate having the gold wiring formed thereon. More specifically, the paste was printed on a predetermined region of the gold wiring through a mask (50 μm in thickness) having a size of 2 mm×3 mm. The printed paste was then dried and sintered at a temperature of 450° C. for 30 minutes. These steps of printing and drying were repeated four times to form a porous titania film having a thickness of 20 μm, thus obtaining the porous layer 15.

A glass substrate having a thickness of 1 mm was prepared as a second substrate 11b to be disposed to face the first substrate 11a. The first substrate 11a and the second substrate 11b were disposed to face each other with an ionomer resin having a thickness of 40 μm being interposed therebetween. Subsequently, these substrates were bonded to each other except the inlet port which was left as it was, thus obtaining a cell.

An electrolyte was prepared in the same manner as described in Sample 1 except that the ionic liquid was changed to 9 g of N-methyl-N-butyl pyrrolidinium bis(trifluoromethyl sulfonyl)imide. Further, the light-emitting device as shown in FIG. 5 was manufactured in the same manner as described in Sample 15 except that the electrolyte thus prepared was employed.

When an AC current was passed through the light-emitting device thus obtained in order to investigate the emission initiating voltage, the voltage was 1.8V. Further, the luminance at a voltage of 3V was 400 cd/m².

As described above, since carbonate which is solid at normal temperature is contained in the electrolyte constituting the light-emitting layer in the light-emitting device according to embodiments, it is now possible to reduce the emission initiating voltage and to enhance the emission luminance.

Incidentally, the present invention should not be construed as being limited to the foregoing embodiments. Namely, the constituent elements of the present invention can be variously modified in practicing the present invention within the scope of the invention. Further, a plurality of constituent elements disclosed in the foregoing embodiments may be optionally combined to create various forms of invention. For example, some of the constituent elements illustrated in the foregoing embodiments may be eliminated. Furthermore, the constituent elements illustrated in different embodiments described above may be optionally combined.

According to one embodiment of the present invention, it is possible to provide a light-emitting device which is capable of being driven with low voltages and emitting high luminance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light-emitting device comprising:
a first electrode;
a second electrode electrically isolated from the first electrode; and
a luminescence layer formed of an electrolyte and disposed to contact with both of the first electrode and second electrode, the electrolyte comprising a luminous pigment which emits light, an ionic liquid, and carbonate, the carbonate being solid at normal temperature.

2. The light-emitting device according to claim 1, wherein the carbonate is selected from a group consisting of ethylene carbonate, benzylphenyl carbonate, ethyl-m-tolyl carbonate, ethylphenyl carbonate, t-butyl-4-vinylphenyl carbonate, t-butylphenyl carbonate, t-butylethyl-3,5-xylyl carbonate, allylphenyl carbonate, diallyl carbonate and dibenzyl carbonate.

3. The light-emitting device according to claim 2, wherein the carbonate is ethylene carbonate.

4. The light-emitting device according to claim 3, wherein the ethylene carbonate is within a range of 3 to 40% by weight based on a total weight of the ionic liquid and the carbonate.

5. The light-emitting device according to claim 4, wherein the ethylene carbonate is within a range of 5 to 20% by weight based on a total weight of the ionic liquid and the carbonate.

6. The light-emitting device according to claim 1, wherein the ionic liquid included in the electrolyte is a normal temperature molten salt comprising an anion and a cation having a structure represented by a following general formula (A).

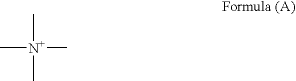

7. The light-emitting device according to claim 6, wherein the cation is N-methyl-N-propyl pyrrolidinium ion.

8. The light-emitting device according to claim 6, wherein the anion is selected from the group consisting of BF₄⁻, [BF₃(CF₃)]⁻, [BF₃(C₂F₅)]⁻, [B(COOCOO)₂]⁻, [(CF₃SO₂)₂N]⁻ and [(C₂F₅SO₂)₂N]⁻.

9. The light-emitting device according to claim 8, wherein the anion is [(CF₃SO₂)₂N]⁻.

10. The light-emitting device according to claim 1, further comprising a porous layer disposed on at least one of the first electrode and the second electrode.

11. The light-emitting device according to claim 10, wherein the porous layer has a thickness ranging from 1 to 50 μm.

12. The light-emitting device according to claim 10, wherein the porous layer is constituted by an aggregate of titania fine particles.

13. The light-emitting device according to claim 12, wherein a particle diameter of the titania fine particles ranges from 5 to 300 nm.

14. The light-emitting device according to claim 1, wherein the luminous pigment contained in the electrolyte is a Ru complex.

15. The light-emitting device according to claim 14, wherein the Ru complex comprises a ligand selected from the group consisting of pyridine derivatives, bipyridyl derivatives, terpyridyl derivatives, phenanthroline derivatives, quinoline derivatives, acetylacetone derivatives and dicarbonyl derivatives.

16. A light-emitting device comprising:
a first electrode;
a second electrode disposed to face the first electrode and spaced apart therefrom; and
a luminescence layer formed of an electrolyte and interposed between the first electrode and the second electrode to contact with both of the first electrode and second electrode, the electrolyte comprising a luminous pigment which emits light, an ionic liquid, and carbonate, the carbonate being solid at normal temperature.

17. The light-emitting device according to claim 16, wherein the is selected from a group consisting of ethylene carbonate, benzylphenyl carbonate, ethyl-m-tolyl carbonate, ethylphenyl carbonate, t-butyl-4-vinylphenyl carbonate, t-butylphenyl carbonate, t-butylethyl-3,5-xylyl carbonate, allylphenyl carbonate, diallyl carbonate and dibenzyl carbonate.

18. The light-emitting device according to claim 16, wherein the ionic liquid included in the electrolyte is a normal temperature molten salt comprising an anion and a cation having a structure represented by the following general formula (A).

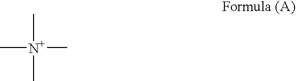

19. A light-emitting device comprising:
an insulating substrate;
a first tandem electrode disposed on the insulating substrate;
a second tandem electrode disposed to electrically insulate from the first tandem electrode and formed on the insulating substrate; and
a luminescence layer formed of an electrolyte and interposed to contact with both of the first tandem electrode and second tandem electrode, the electrolyte comprising a luminous pigment which emits light, an ionic liquid, and carbonate, the carbonate being solid at normal temperature.

20. The light-emitting device according to claim 19, wherein the carbonate is selected from the group consisting of ethylene carbonate, benzylphenyl carbonate, ethyl-m-tolyl carbonate, ethylphenyl carbonate, t-butyl-4-vinylphenyl carbonate, t-butylphenyl carbonate, t-butylethyl-3,5-xylyl carbonate, allylphenyl carbonate, diallyl carbonate and dibenzyl carbonate.
